(19) United States
(12) Patent Application Publication
(10) Pub. No.: US 2022/0164804 A1
(43) Pub. Date: May 26, 2022

(54) System and method for proof of authenticity and ledger of ownership

(71) Applicants: Lilach Frida Friedman Ashkenazi, Tel Aviv (IL); Michael Balin, Tel Aviv (IL)

(72) Inventors: Lilach Frida Friedman Ashkenazi, Tel Aviv (IL); Michael Balin, Tel Aviv (IL)

(21) Appl. No.: 17/103,975

(22) Filed: Nov. 25, 2020

(51) Int. Cl. G06Q 30/00; H04L 9/32; G06F 21/62; G01S 19/01

(52) U.S. Cl. CPC G06Q 30/018; H04L 9/3226; H04B 5/0025; G01S 19/01; H04L 2209/38; G06F 21/62

(57) ABSTRACT

The present invention relates to the field of smart electronic communication system and more particularly relates to ownership authenticity and ledger system based on Near-Field-Communication (NFC) or Radio-frequency identification (RFID) tagging systems. Existing systems and methods of authenticating ownership or partial ownership or shared ownership and maintaining owner related information and identity security linked to a product have numerous weaknesses. For instance, the safety of private owner information, such as a social security number (SSN) other personal details is important when a product has been sold by a retailer or a seller to a consumer. Specifically, when a product such as artworks, artifacts, designer pieces, collectable goods are sold, there is a need to have an authenticated document usually authorized by a third-party professional every time when a product has been sold or resold. The present invention provides a unique system and method that works when a authenticity tag is embedded as a part of the production on the physical goods or after production, to the artwork, designer piece or any physical good that can be associated with an energy source that can support a smart card NFC/RFID protocol that can run the source code and read the data.

### CROSS-REFERENCE TO RELATED APPLICATIONS

No related applications are previously filed.

### TECHNICAL FIELD OF THE INVENTION

The present invention relates to the field of smart electronic communication system and more particularly relates to ownership authenticity and ledger system based on Near-Field-Communication (NFC) or Radio-frequency identification (RFID) tagging systems.

### BACKGROUND OF THE INVENTION

Existing systems and methods of authenticating ownership and maintaining owner related information and identity security linked to a product have numerous weaknesses. For instance, the safety of private owner information, such as a social security number (SSN) other personal details is important when a product has been sold by a retailer or a seller to a consumer. Specifically, when a product such as artworks, artifacts, designer pieces, collectable goods are sold, there is a need to have an authenticated document usually authorized by a third-party professional every time when a product has been sold or resold.

Another problem is managing the ledger of ownership of a product which has a capability of replication. For example, products related to digital arts, designer artifacts or creative work have to be authenticated for their originality and also when the same product is sold, it is problematic to keep a track of the ownership specifically when the same product is resold by the buyer to another buyer. The same issues arises when multiple copies of similar artwork has been created and authenticating the each product for their originality is complicated when there no appropriate authorizing system that can appropriately authorize the goods and provide a proper distributed ownership ledger and price change of each transaction of the goods for further monitoring and management of distributed micro ledger of ownership and price discovery.

There are a few inventions that have been enlisted in prior art that provides different methods and systems for verification of information using a centralized or distributed ledger. For example, a recent US Patent US20200177377A1 assigned to Civic Technologies Inc. provides a unique system and method for attestation of information with use of a centralized or distributed ledger. However, there remains a need for improved devices, systems, and methods for supporting proof of authenticity and ledger of ownership system.

None of the prior art inventions and patents, taken either alone or in combination, is effective to overcome the identified defects of providing an appropriate system and/or method that can address the issue of supporting proof of authenticity. Additionally, none of the prior art inventions and, taken either alone or in combination, is effective to overcome drawbacks of ledger ownership system that can be useful for securely monitoring and managing the details of ownership of products or goods.

Hence, the present invention proposes to resolve the existent technical difficulties to eliminate the shortcomings of prior art. The present invention provides a unique system and method that works when a authenticity tag is embedded as a part of the production on the physical goods or after production, to the artwork, designer piece or any physical good that can be associated with an energy source that can support a smart card NFC/RFID protocol that can run the source code and read the data.

### SUMMARY OF THE INVENTION

Embodiments of the invention solve the above-mentioned problems by providing a unique system and method that works when a authenticity tag is embedded as a part of the production on the physical goods or after production, to the artwork, designer piece or any physical good that can be associated with an energy source that can support a smart card NFC/RFID protocol that can run the source code and read the data. The ownership or partial ownership or shared ownership authentication and amendment system comprises at least one product that is on the sale, at least one authenticity tag associated to at least one product and including a confidential encryption code and a unique identifier, a position locating system, a private ledger system associated to each of the products and the unique identifier and authentication data of each of the products, wherein the private ledger comprises one or more transactions associated with the products and the authentication data is stored in a private database which is only accessible to the manufacturer or sealer or any authorized third party and is amendable by producing the confidential encryption code associated to specific authenticity tags embedded to the product and a device storing an authentication.

In accordance with one aspect of a preferred method of the present invention, a method of using ownership or partial ownership or shared ownership authentication and amendment system is disclosed. The method of using ownership or partial ownership or shared ownership authentication and amendment system including at least one product that is on the sale, at least one authenticity tag associated to at least one product and including a confidential encryption code and a unique identifier, a private ledger system associated to each of the products and the unique identifier and authentication data of each of the products, wherein the private ledger comprises one or more transactions associated with the products and the authentication data is stored in a private database which is only accessible to the manufacturer or sealer or 3rd authorized party and is amendable by producing the confidential encryption code associated to specific authenticity tags embedded to the product and a device storing an authentication application, the method comprising steps of (1) wirelessly read the unique identifier and the confidential encryption code from at least of the authenticity tags, (2) connecting to the manufacturer or sealer or any authorized third party's server and search the stored records and identify the authentication data of the products associated with the at least of the products tags based on the unique identifier, (3) authenticating the products associated with at least one authenticity tag based on the authentication data and the confidential encryption code, (4) wirelessly communicating the authenticity tag using Near-Field-Communication (NFC) or Radio-frequency identification (RFID) systems, (5) requesting for a confidential encryption code via the ledger controller web server, (6) approving the confidential encryption code in the device using the web data storage ledger control manager, (7) unlocking the ledger and updating the relevant ownership or partial ownership or shared ownership data relevant information relevant to the product, (8) confirming the updated data and sending the updated data to the web data storage ledger control manager.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description, figures, and claims.

### BRIEF DESCRIPTION OF THE DRAWINGS

Embodiments of the invention are described in detail below with reference to the attached drawing figures, wherein:

FIG. 1 diagrammatically visualizes the components of the proof of authenticity and ledger of ownership or partial ownership or shared ownership system and their respective workflow.

FIG. 2 provides a flow diagram describing the method of authentication.

FIG. 3 provides a flow diagram describing the method of ledger ownership or partial ownership or shared ownership.

### DETAILED DESCRIPTION OF THE INVENTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, embodiments of the invention can include a variety of combinations and/or integrations of the embodiments described herein.

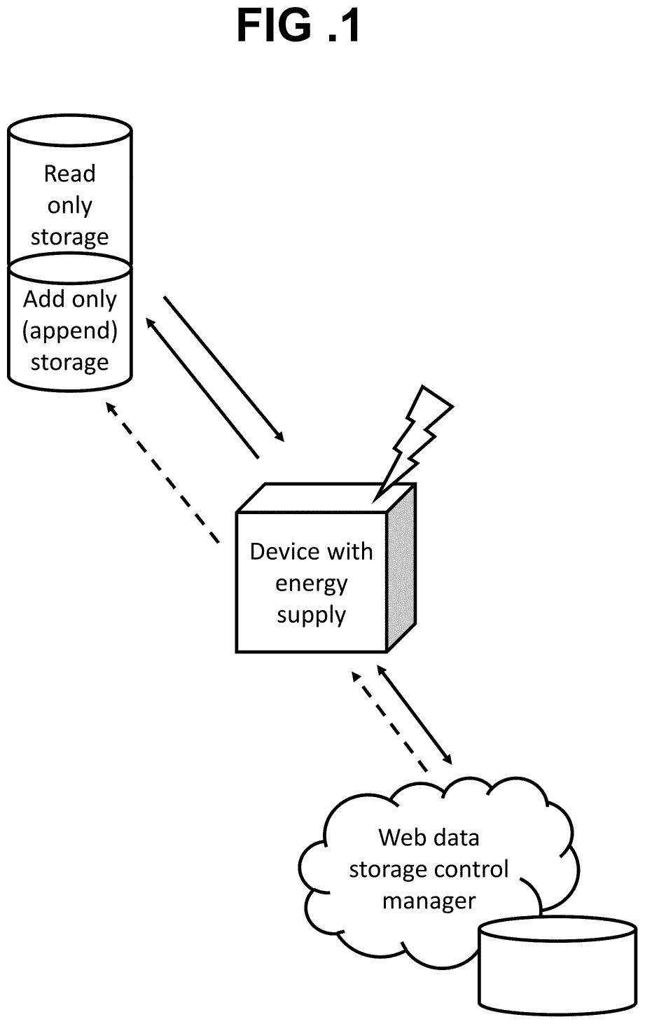

Turning to the figures and specifically FIG. 1, embodiments of the present invention comprise an ownership or partial ownership or shared ownership authentication and amendment system, the system comprising at least one product that is on the sale, at least one authenticity tag associated to at least one product and including a confidential encryption code and a unique identifier, a position locating system, a private ledger system associated to each of the products and the unique identifier and authentication data of each of the products, wherein the private ledger comprises one or more transactions associated with the products and the authentication data is stored in a private database which is only accessible to the manufacturer or sealer or any authorized third party and is amendable by producing the confidential encryption code associated to specific authenticity tags embedded to the product and a device storing an authentication.

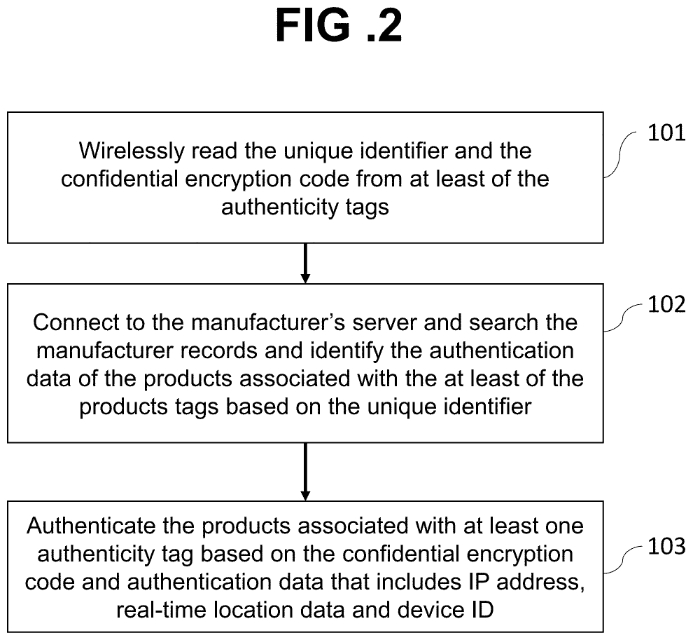

Now referring to FIG. 2 that provides flow diagram describing the method of authentication, wherein the method comprises steps of wirelessly read the unique identifier and the confidential encryption code from at least of the authenticity tags 101, connecting to the manufacturer or sealer or any authorized third party's server and search the stored records and identify the authentication data of the products associated with the at least of the products tags based on the unique identifier 102 and authenticating the products associated with at least one authenticity tag based on the confidential encryption code and authentication data that includes IP address, real-time location data and device ID 103.

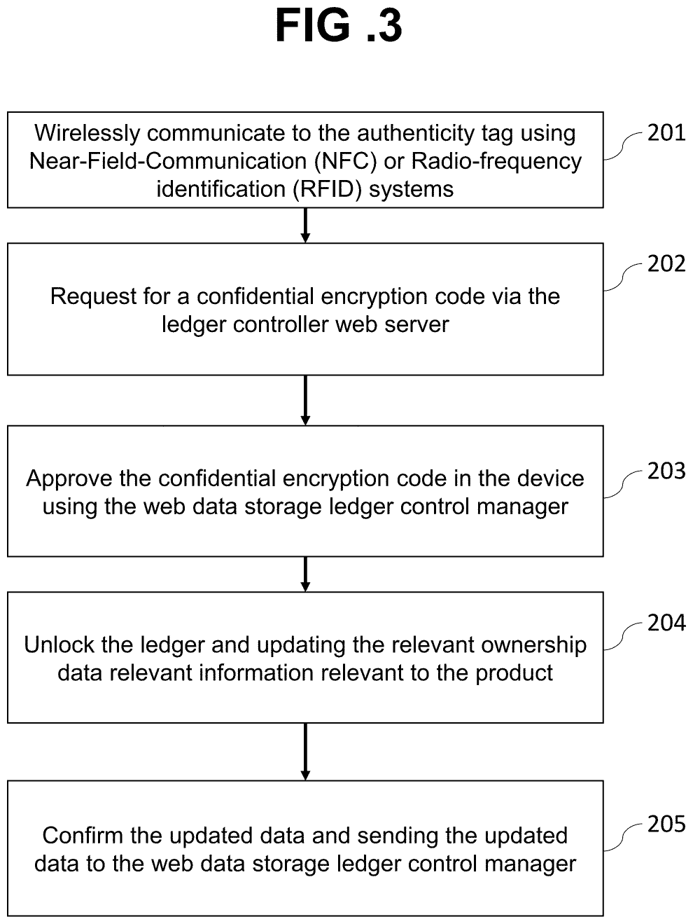

Referring to FIG. 3 provides a flow diagram describing the method of ledger ownership or partial ownership or shared ownership, wherein the method comprises steps of wirelessly communicating the authenticity tag using Near-Field-Communication (NFC) or Radio-frequency identification (RFID) systems 201, requesting for a confidential encryption code via the ledger controller web server 202, approving the confidential encryption code in the device using the web data storage ledger control manager 203, unlocking the ledger and updating the relevant ownership or partial ownership or shared ownership data relevant information relevant to the product 204, confirming the updated data and sending the updated data to the web data storage ledger control manager 205.

In one embodiment of the present invention, the grow tent assembly includes at least one foldable height adjustment cover panel, wherein the said foldable height adjustment cover panel further includes attachment means that enables detachable attachment of the said foldable height adjustment cover panel to the horizontal closable opening of the said six wall cover panels and enables users to vertically extend the height of the said tent assembly.

In one embodiment of the present invention, the authenticity tag is capable to communicate using Near-Field-Communication (NFC) or Radio-frequency identification (RFID) systems.

In the same embodiment of the present invention, the position locating system is a Global Positioning System (GPS) receiver that is useful to identify the real-time location of the product in the case of a theft or misplacement.

In the same embodiment of the present invention, the ownership data includes data related to partial, shared and complete ownership.

In the same embodiment of the present invention, the data is protected using a confidential encryption code which is only accessible to the manufacturer or sealer or any authorized third party of the product.

In the same embodiment of the present invention, the data is amendable via a privately controlled distributed ledger system.

In the same embodiment of the present invention, the new ownership is added after every new successful transaction.

In the same embodiment of the present invention, the local storage of the device contains a record of all other partial, shared, complete owners and is be updated with the new owner information every time when the product is sold directly by the seller, manufacturer or sealer or any authorized third party and retailer.

In the same embodiment of the present invention, the confidential encryption code is be approved via the ledger controller web server.

Although embodiments of the invention have been described with reference to the embodiments illustrated in the attached drawing figures, it is noted that equivalents may be employed and substitutions made herein without departing from the scope of the invention as recited in the claims.

Having thus described in various embodiments of the invention, what is claimed as new and desired to be protected by Letters Patent includes the following:

1. An ownership authentication and amendment system, the system comprising:
at least one product that is on the sale;
at least one authenticity tag associated to at least one product and including a confidential encryption code and a unique identifier;
a position locating system;
a private ledger system associated to each of the products and the unique identifier and authentication data of each of the products, wherein the private ledger comprises one or more transactions associated with the products and the authentication data is stored in a private database which is only accessible to the manufacturer or sealer or any authorized third party and is amendable by producing the confidential encryption code associated to specific authenticity tags embedded to the product; and
a device storing an authentication application configured to:
wirelessly read the unique identifier and the confidential encryption code from at least of the authenticity tags;
connect to the manufacturer or sealer or any authorized third party's server and search the stored records and identify the authentication data of the products associated with the at least of the products tags based on the unique identifier;
authenticate the products associated with at least one authenticity tag based on the confidential encryption code and authentication data that includes IP address, real-time location data and device ID;
wirelessly communicate to the authenticity tag using Near-Field-Communication (NFC) or Radio-frequency identification (RFID) systems;
request for a confidential encryption code via the ledger controller web server;
approve the confidential encryption code in the device using the web data storage ledger control manager;
unlock the ledger and updating the relevant ownership data relevant information relevant to the product;
confirm the updated data and sending the updated data to the web data storage ledger control manager.

2. The system of claim 1, wherein the authenticity tag is capable to communicate using Near-Field-Communication (NFC) or Radio-frequency identification (RFID) systems.

3. The system of claim 1, wherein the authenticity of at least one product and all relative attributes to it includes website URL, text and images.

4. The system of claim 1, wherein the position locating system is a Global Positioning System (GPS) receiver that is useful to identify the real-time location of the product in the case of a theft or misplacement.

5. The system of claim 1, wherein the ownership data includes data related to partial, shared and complete ownership.

6. The system of claim 1, wherein the data is protected using a confidential encryption code which is only accessible to the manufacturer, sealer and the authorized third party of the product.

7. The system of claim 5, wherein the data is amendable via a privately controlled distributed ledger system.

8. The system of claim 1, wherein the new ownership is added after every new successful transaction.

9. The system of claim 1, wherein the local storage of the device contains a record of all other partial, shared, complete owners and is be updated with the new owner information every time when the product is sold by the manufacturer, sealer and the authorized third party.

10. The system of claim 1, wherein the confidential encryption code is be approved via the ledger controller web server.

11. A method of using ownership authentication and amendment system including at least one product that is on the sale, at least one authenticity tag associated to at least one product and including a confidential encryption code and a unique identifier, a private ledger system associated to each of the products and the unique identifier and authentication data of each of the products, wherein the private ledger comprises one or more transactions associated with the products and the authentication data is stored in a private database which is only accessible to the manufacturer, sealer and the authorized third party and is amendable by producing the confidential encryption code associated to specific authenticity tags embedded to the product and a device storing an authentication application, the method comprising steps of:
wirelessly reading the unique identifier and the confidential encryption code from at least of the authenticity tags;
connecting to the manufacturer, sealer and the authorized third party's server and search the stored records and identify the authentication data of the products associated with the at least of the products tags based on the unique identifier;
authenticating the products associated with at least one authenticity tag based on the confidential encryption code and authentication data that includes IP address, real-time location data and device ID;
wirelessly communicating the authenticity tag using Near-Field-Communication (NFC) or Radio-frequency identification (RFID) systems;
requesting for a confidential encryption code via the ledger controller web server;
approving the confidential encryption code in the device using the web data storage ledger control manager;
unlocking the ledger and updating the relevant ownership data relevant information relevant to the product;
confirming the updated data and sending the updated data to the web data storage ledger control manager.

12. The method of claim 11, wherein the authenticity tag is capable to communicate using Near-Field-Communication (NFC) or Radio-frequency identification (RFID) systems.

13. The method of claim 11, wherein the authenticity of at least one product and all relative attributes to it includes website URL, text and images.

14. The method of claim 11, wherein the position locating system is a Global Positioning System (GPS) receiver that is useful to identify the real-time location of the product in the case of a theft or misplacement.

15. The method of claim 11, wherein the ownership data includes data related to partial, shared and complete ownership.

16. The method of claim 11, wherein the data is protected using a confidential encryption code which is only accessible to the manufacturer, sealer and the authorized third party of the product.

17. The method of claim 16, wherein the data is amendable via a privately controlled distributed ledger system.

18. The method of claim 11, wherein the new ownership is added after every new successful transaction.

19. The method of claim 11, wherein the local storage of the device contains a record of all other partial, shared, complete owners and is be updated with the new owner information every time when the product is sold directly by the manufacturer, sealer and the authorized third party.

20. The method of claim 11, wherein the confidential encryption code is be approved via the ledger controller web server.
